(19) United States
(12) Patent Application Publication
(10) Pub. No.: US 2006/0059415 A1
(43) Pub. Date: Mar. 16, 2006

(54) Data processing system, control method therefor, document input apparatus, control method therefor, document managing apparatus, control method therefor, programs for implementing the control methods, and storage media storing the control programs

(75) Inventor: Tadashi Hagiuda, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/219,215

(22) Filed: Sep. 2, 2005

(30) Foreign Application Priority Data
Sep. 2, 2004 (JP) 2004-256207

(51) Int. Cl. G06F 17/21; G06F 3/12

(52) U.S. Cl. 715/500; 358/1.15

(57) ABSTRACT

A data processing system that enables a plurality of users to share an input format for data on a document by document basis. In a document generating system as a data processing system, a plurality of multi-function devices 120 and a document managing server 100 are connected to each other for communication therebetween. The document managing server 100 stores templates each defining therein an input format for document data. Each of the multi-function devices 120 transmits a template identifier (ID) assigned to a selected template to the document managing server 100. The document managing server 100 transmits an input format defined in the template corresponding to the received template identifier to each of the multi-function devices 120. Each of the multi-function devices 120 sets the received input format, inputs document data according to the set input format, and transmits the inputted document data with addition of information indicative of a processing method to the document managing server 100. The document managing server 100 processes the document data received with the information, according to the information.

### BACKGROUND OF THE INVENTION

1. Field of the Invention

The present invention relates to generation of document data using data obtained by scanning an original, and more particularly to a data processing system, a control method therefor, a document input apparatus, a control method therefor, and a document managing apparatus, a control method therefor, which are suitable for generating document data having a common structure from one or a plurality of data inputted to an arbitrary multi-function device MFP (Multi Function Peripheral), by using templates managed by a server, programs for implementing the control methods, and storage media storing the control programs.

2. Description of the Related Art

In recent years, with the development of OA equipment, there have been developed multi-function devices which have a printer function, a copy function, and a facsimile function which were conventionally realized by separate devices, and are widely used in offices. Multi-function devices are generally used while they are connected to a network, and can carry out processes, such as printing various document data created on a client PC on the network, printing image data of an original inputted from a scanner, and transmitting image data using the G3 facsimile protocol to a designated device (a PC connected to the network via a modem, a facsimile machine, or a multi-function device, etc.).

Further, recently, multi-function devices have appeared, which are connected to the Internet and have various document transmitting functions, such as transmitting image data to a designated PC, and transmitting image data to another multi-function device via the Internet, for printing out image data.

On the other hand, a technique of transferring data has been proposed in Japanese Laid-Open Patent Publication (Kokai) No. H05-292240, in which a scanner printer server with a scanner and a printer connected thereto, is connected to a host computer via a network, and two-way communication paths are provided between the scanner and printer and the scanner printer server such that the host computer designates a transfer method of transferring text, graphics and image data to be scanned and printed, and the image data is transferred according to the designated transfer method.

Japanese Laid-Open Patent Publication (Kokai) No. 2001-274943 has proposed a technique applied to a system including a computer that receives input for creating a scan order, an order-entry server computer that creates and distributes the scan order, and a scanner node that processes the scan order which has been transmitted or searched for creating the scan order, providing the created scan order for the scan node so that the scan node processes the scan order, and updating the system upon completion of the scan order.

However, the above document transmission by the conventional multi-function devices connected to the Internet suffers from the following problems. That is, when transmitting a document, it is necessary to set various parameters, such as reading size (designation of A4 size, B4 size, or a desired magnification), resolution (designation of 100×100 dpi, 200×200 dpi, etc.), and reading mode (designation of color binary, black/white binary etc.). Further, it is necessary to make not only settings related to the scanner including frame erase but also setting of other parameters such as file format (designation of TIFF (Tagged Image File Format), PDF (Portable Document Format), or the like), transmitting method (FTP (File Transfer Protocol), IFax, mail attachment), and destination address including information on a storage area for an image file.

Therefore, when a large amount of image data read from originals is divided between a plurality of users to upload the image data to a server PC via multi-function devices, each user has to be aware of various parameters as mentioned above, and further, each user has to directly set these parameters in the multi-function device by himself/herself.

Further, in the above case where divided image data are uploaded to a server PC, an image file is generated in the server PC in which image data are arranged in the order in which the plurality of divided image data from the originals have been inputted. Therefore, when printing the plurality of divided image data or when combining the plurality of divided image data into a single image file, the user has to be conscious of the proper order of the images before printing out the image data or combining into the single image file.

### SUMMARY OF THE INVENTION

It is an object of the present invention to provide a data processing system, a control method therefor, a document input apparatus, a control method therefor, and a document managing apparatus, and a control method therefore, which enable a plurality of users to share an input format for data on a document by document basis, enable a plurality of document data to be outputted in proper order, and enable a plurality of document data to be converted and synthesized into a unified format, as well as programs for implementing the control methods, and storage media storing the control programs.

To attain the above object, in a first aspect of the present invention, there is provided a data processing system comprising, a document input apparatus that inputs document data, and a document managing apparatus that stores templates each defining therein an input format for document data, the document input apparatus and the document managing apparatus being connected to each other for communication therebetween, wherein the document input apparatus comprises a first transmission section that transmits information used for selecting a template to the document managing apparatus, a first reception section that receives an input format defined in the template for document data from the document managing apparatus, a setting section that sets the received input format, an input section that inputs document data according to the set input format, and a second transmission section that transmits the document data inputted according to the set input format with addition of information indicative of a processing method, to the document managing apparatus, and the document managing apparatus comprises a second reception section that receives the information used for selecting a template from the document input apparatus, a third transmission section that transmits an input format defined in the template to the document input apparatus, a third reception section that receives the document data and the information indicative of the processing method from the document input apparatus, and a processing section that processes the document data according to the information indicative of the processing method.

Preferably, the information indicative of the processing method is sort information indicative of an output order, and the document managing apparatus carries out sorting on the received document data according to the sort information.

Preferably, the input format for document data includes at least one parameter selected from the group consisting of reading size, resolution, reading mode, file format, transmitting method, and destination address including a storage area for the document data.

Preferably, the templates each define therein a conversion method and a synthesizing method for document data in addition to the input format for document data, and the document managing apparatus converts and synthesizes the received document data according to the conversion method and the synthesizing method defined in a selected one of the templates.

Preferably, the data processing system comprises at least one output device that is connected to the document managing apparatus for communication therewith, for printing out document data, and the document managing apparatus comprises a fourth transmission section that is operable when document data corresponding to a document identifier received from the output device exists, to transmit the corresponding document data, to the output device.

According to the configuration of the first aspect, the document input apparatus transmits information used for selecting a template to the document managing apparatus, inputs document data according to an input format for document data transmitted from the document managing apparatus, and then transmits the inputted document data and sort information to the document managing apparatus. The document managing apparatus carries out sorting on the document data transmitted from the document input apparatus according to the sort information. As a result, it is possible for a plurality of users to share an input format for data on a document by document basis, and further, a plurality of document data can be outputted in the proper order.

To attain the above object, in a second aspect of the present invention, there is provided a document input apparatus that can communicate with a document managing apparatus storing templates each defining therein an input format for document data, comprising a first input section that inputs information used for selecting a template, a first notifying section that transmits the information used for selecting a template inputted by the first input section to the document managing apparatus, a reception section that receives an input format defined in the template for document data from the document managing apparatus, a setting section that sets the received input format, a second input section that inputs document data according to the set input format, and a second notifying section that transmits the document data inputted according to the set input format, with addition of information indicative of a processing method, to the document managing apparatus.

Preferably, the information indicative of the processing method is sort information indicative of an output order.

Preferably, the input format for document data includes at least one parameter selected from the group consisting of reading size, resolution, reading mode, file format, transmitting method, and destination address including a storage area for the document data.

To attain the above object, in a third aspect of the present invention, there is provided a document managing apparatus that can communicate with at least one document input apparatus that inputs document data, comprising a storage section that stores templates each defining therein an input format for document data, a first reception section that receives information used for selecting a template from the document input apparatus, a notifying section that is operable when one of the templates corresponding to the information used for selecting a template is stored in the storage section, to transmit the input format for document data defined in the corresponding template to the document input apparatus, a second reception section that receives the document data and the information indicative of a processing method from the document input apparatus, and a processing section that processes the document data according to the information indicative of the processing method.

Preferably, the information indicative of the processing method is sort information indicative of an output order, and the processing section carries out sorting on the received document data according to the sort information.

Preferably, the input format for document data includes at least one parameter selected from the group consisting of reading size, resolution, reading mode, file format, transmitting method, and destination address including a storage area for the document data.

Preferably, the templates each define therein a conversion method and a synthesizing method for document data in addition to the input format for document data, and the processing section converts and synthesizes the received document data according to the conversion method and the synthesizing method defined in a selected one of the templates.

Preferably, the document managing apparatus can communicate with at least one output device that prints document data, and the document managing apparatus transmits document data corresponding to a document identifier received from the output device, to the output device, when the corresponding document data exists.

According to the configuration of the third aspect, the document managing apparatus converts and synthesizes document data according to the conversion method and synthesizing method for the document data defined in a selected one of the templates. As a result, a plurality of document data transmitted from one or more of the document input apparatuses to the document managing apparatus can be converted and synthesized into a unified format.

To attain the above object, in a fourth aspect of the present invention, there is provided control method of controlling a data processing system comprising a document input apparatus that inputs document data, and a document managing apparatus that stores templates each defining therein an input format for document data, the document input apparatus and the document managing apparatus being connected to each other for communication therebetween, the control method comprising a first transmitting step of transmitting a information used for selecting a template to the document managing apparatus, a first receiving step of receiving an input format defined in the template for document data from the document managing apparatus, a setting step of setting the received input format, an input step of inputting document data according to the set input format, a second transmitting step of transmitting the document data inputted according to the set input format with addition of information indicative of a processing method, to the document managing apparatus, a second reception step of receiving the information used for selecting a template from the document input apparatus, a third transmitting step of transmitting an input format defined in the template to the document input apparatus, a third receiving step of receiving the document data and the information indicative of the processing method from the document input apparatus, and a processing step of processing the document data according to the information indicative of the processing method, wherein the first transmitting step, the first receiving step, the setting step, and the second transmitting step are carried out by the document input apparatus, and the second receiving step, the third transmitting step, the third receiving step, and the processing step are carried out by the document managing apparatus.

To attain the above object, in a fifth aspect of the present invention, there is provided a control method of controlling a document input apparatus that can communicate with a document managing apparatus storing templates each defining therein an input format for document data, comprising a first notifying step of transmitting information used for selecting a template to the document managing apparatus, a setting step of setting the received input format, an input step of inputting document data according to the set input format, and a second notifying step of transmitting document data inputted according to the input format set in the setting step, with addition of information indicative of a processing method, to the document managing apparatus.

To attain the above object, in a sixth aspect of the present invention, there is provided a control method of controlling a document managing apparatus that can communicate with at least one document input apparatus that inputs document data, comprising a storing step of storing templates each defining therein an input format for document data in a storage device of the document managing apparatus, a first receiving step of receiving information used for selecting a template from the document input apparatus, a notifying step of transmitting the input format for document data defined in one of the templates corresponding to the information used for selecting a template to the document input apparatus when the corresponding template is stored in the storage device, a second receiving step of receiving the document data and the information indicative of a processing method from the document input apparatus, a processing step of processing the document data according to the information indicative of the processing method.

To attain the above object, in a seventh aspect of the present invention, there is provided a program for causing a computer to execute the control method of controlling a document input apparatus according to the fifth aspect of the present invention.

To attain the above object, in an eighth aspect of the present invention, there is provided a program for causing a computer to execute the control method of controlling a document managing apparatus according to the sixth aspect of the present invention.

To attain the above object, in a ninth aspect of the present invention, there is provided a computer-readable storage medium storing the program according to the seventh aspect of the present invention.

To attain the above object, in a tenth aspect of the present invention, there is provided a computer-readable storage medium storing the program according to the eighth aspect of the present invention.

The above and other objects, features, and advantages of the present invention will become more apparent from the following detailed description taken in conjunction with the accompanying drawings.

### BRIEF DESCRIPTION OF THE DRAWINGS

FIG. 1 is a block diagram showing the construction of a document generating system as a data processing system according to a first embodiment of the present invention;

FIG. 2 is a block diagram showing in detail the construction of the document generating system;

FIG. 3A is a flowchart showing a process for uploading document data from a multi-function device appearing in FIG. 2, to a document managing server appearing in FIG. 2;

FIG. 3B is a flow chart showing a continued part of the process in FIG. 3A;

FIG. 4A is a flowchart showing a process for uploading document data from a plurality of multi-function devices to the document managing server appearing in FIG. 1, and outputting document data according to an output request from an output device connected to a network;

FIG. 4B is a flow chart showing a continued part of the process in FIG. 4A;

FIG. 5 is a flowchart showing in detail a process carried out when the output device connected to the network requests output of document data to the document managing server appearing in FIG. 2; and

FIG. 6 is a block diagram showing the construction of a document generating system as a data processing system according to a second embodiment of the present invention.

### DETAILED DESCRIPTION OF THE PREFERRED EMBODIMENTS

The present invention will now be described in detail with reference to the drawings showing preferred embodiments thereof. It should be noted that the arrangement of the components, the numerical expressions and numerical values set forth in these embodiments do not limit the scope of the present invention unless it is specifically stated otherwise.

First, a description will be given of a data processing system according to a first embodiment of the present invention.

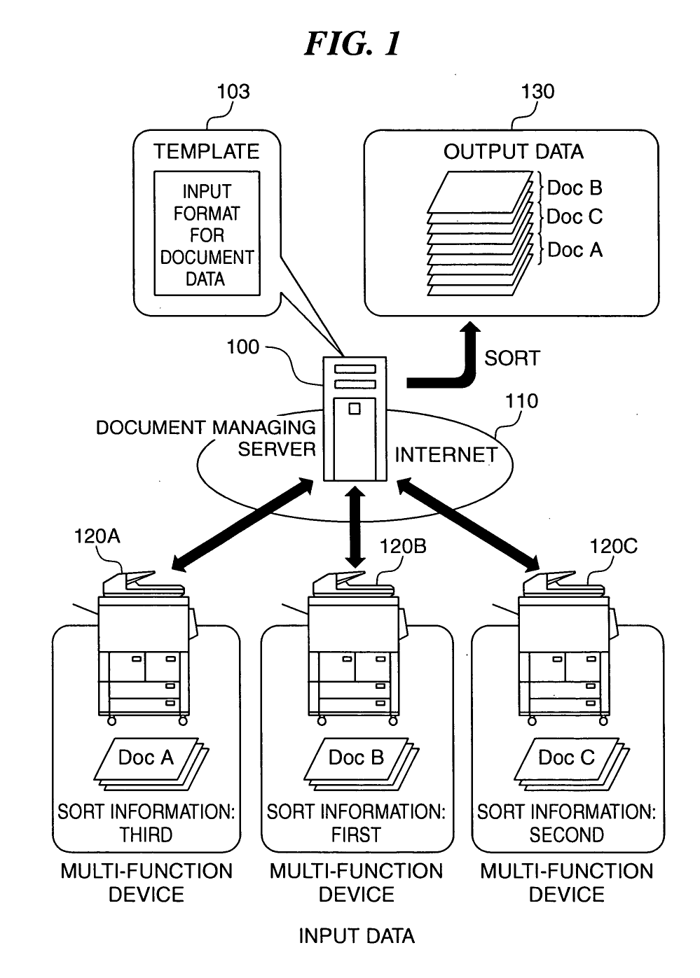

FIG. 1 is a block diagram showing the construction of a document generating system as the data processing system according to the first embodiment.

As shown in FIG. 1, the document generating system is comprised of a document managing server 100, and a plurality of multi-function devices, i.e., a multi-function device 120A, a multi-function device 120B, and a multi-function device 120C. These multi-function devices are connected to the document managing server 100 via the Internet 110. Hereinafter, where appropriate, the multi-function device 120A, the multi-function device 120B, and the multi-function device 120C will be generically referred to as the multi-function device(s) 120.

The document managing server 100 carries out management of document data and other processing, and stores a template file 103 consisting of a plurality of templates. Each template of the template file 103 has defined therein an input format of document data (various input parameters including reading size, resolution, reading mode, file format, transmitting method, and destination address including a storage area for document data).

Each multi-function device 120 has a plurality of functions such as a scanner function, a printer function, and a facsimile function, and transmits document data (Doc A, Doc B, and Doc C) that are inputted, by referring to a template of the template file 103 stored in the document managing server 100, to the document managing server 100. Further, each multi-function device 120 transmits, together with each document data, sort information indicative of an output order for outputting the document data, to the document managing server 100.

When receiving an output request from an output device (such as a printer), not shown, the document managing server 100 generates document data to be outputted 130 (consisting of Doc B, Doc C, and Doc A) by sorting the document data inputted from the multi-function devices 120 with reference to the sort information, and then transmits the document data to the output device. Thus, it is possible for the output device to print out the plurality of document data in the output order indicated by the sort information.

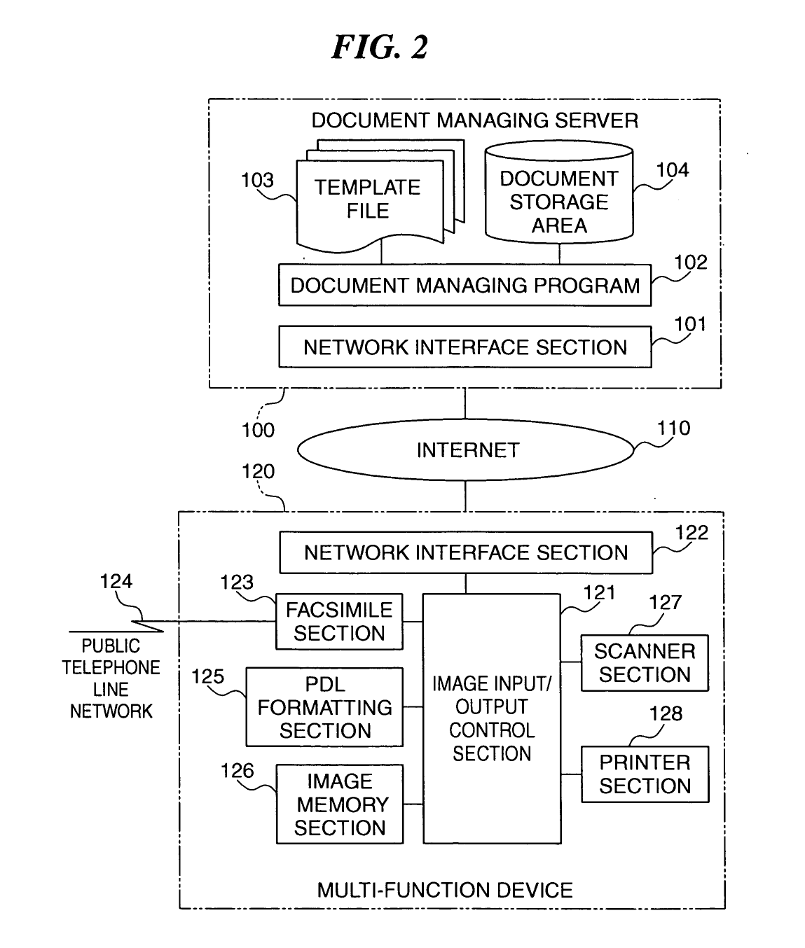

FIG. 2 is a block diagram showing in detail the construction of the document generating system.

As shown in FIG. 2, the document managing server 100 includes a network interface section 101, a document managing program 102, the template file 103, and a document storage area 104. Each multi-function device 120 is comprised of an image input/output control section 121, a network interface section 122, a facsimile section 123, a PDL (Page Description Language) formatting section 125, an image memory section 126, a scanner section 127, a printer section 128, and an operating panel (input means), not shown.

In the document managing server 100, the network interface section 101 controls various kinds of communication protocols used for communication between each multi-function device 120, output devices (not shown), and the like, and transmits and receives data to and from these devices. The document managing program 102 creates and manages the template file 103, and further, receives a template identifier (that is assigned to a template selected by an operator) transmitted from any of the multi-function devices 120, via the network interface section 101, reads the input format for document data that is defined in the template designated by the template identifier and transmits the input format for document data to the multi-function device 120, via the network interface 101.

The document managing program 102 carries out processes such as sorting, data conversion, and/or synthesis of the received document data (specifically, sorting in the first embodiment, and sorting, data conversion, and synthesis in a second embodiment of the present invention, described later), according to the sort information and definitions in a template of the template file.

Each template of the template file 103 has an output format of document data defined therein (in the second embodiment, in addition to the output format of the document data, a conversion method and a synthesizing method are also defined), and each template is assigned a template identifier by the document managing program 102. The document storage area 104 stores document data uploaded from the multi-function devices 120, and is used as a temporary memory area when conversion and synthesis of document data are carried out (refer to the second embodiment described later).

In the present embodiment, the template identifier that is referred to when document data is generated also functions as a document identifier for identifying document data.

In each multi-function device 120, the image input/output control section 121 is connected to the network interface section 122, the facsimile section 123, the PDL formatting section 125, the image memory section 126, the scanner section 127, and the printer section 128, and integratedly controls these function blocks.

The network interface section 122 is a function module that controls communications with various network devices connected to the Internet, receives job control data from external computers (not shown) and other devices, and transmits and receives document data to and from such devices. The job control data includes a job control instruction which is transmitted with PDL data. Examples of the job control data include a job control data that includes a job control instruction for expanding PDL data into image data, printing the image data, and discharging the printed image data by sorting and stapling the print output.

The facsimile section 123 is connected to the image input/output section 121 and a public telephone line network 124, and expands compressed image data received from external multi-function devices via the public telephone line network 124. The expanded image data is printed by the printer section 128 via the image input/output control section 121. Further, the facsimile section 123 reads and compresses image data inputted from the scanner section 127 via the image input/output control section 121, and transmits the compressed image data to external multi-function devices, via the public telephone line network 124.

The PDL formatting section 125 is connected to the image input/output control section 121, and expands PDL data transmitted from an external computer, via the network interface section 122, into image data that can be printed by the printer section 128. The image memory section 126 temporarily stores image data of an original inputted from the scanner section 127 or data transmitted from an external computer via the network interface section 122.

The scanner section 127 reads and converts an image of an original into image data. The image data obtained by the scanner section 127 is transmitted from the facsimile section 123 to an external facsimile machine via the public telephone line network 124, is stored in the image memory section 126, or is printed by the printer section 128 as a copy image. The printer section 128 prints PDL data expanded as image data that is transmitted from an external computer via the network interface section 122, and prints image data received from the public telephone line network 124 via the facsimile section 123.

According to the above construction, each multi-function device 120 refers to the input format of document data (parameters) defined a template of the template file 103 in the document managing server 100, carries out input of document data (scanning images of originals) in the input form through the scanner section 127, and uploads the document data with sort information added, to the documents server 100.

Upon receipt of the document data with the sort information from each multi-function device 120, the document managing server 100 refers to a template of the template file 103 that correspond to the received document data, and determines whether or not the conversion method and synthesizing method for the document data are defined in the template of the template file 103. If it is determined that the conversion method and synthesizing method are defined (in the second embodiment described later), the document managing program 102 carries out conversion and synthesis of the document data and the processed data is stored in the document storage area 104. If it is determined that the conversion method and synthesizing method are not defined (in the present embodiment), only the sorting process, described below, is carried out.

Further, when receiving an output request for outputting document data from an external output device, the document managing server 100 carries out sorting on the document data based on the sort information for the document data that was generated by referring to a template of the template file 103 corresponding to the document data that is requested to be outputted. Then, the sorted document data is converted into an appropriate output format and is transmitted to the external output device.

The present embodiment is characterized in that a template identifier is designated by each multi-function device 120, and parameters defined in the template corresponding to the template identifier, that is transmitted from the document managing server 100 are referred to, to thereby make it possible to generate document data having the same data format from the multi-function devices 120. Further, each multi-function device 120 transmits inputted document data with addition of sort information to the document managing server 100, so that the document managing server 100 can carry out sorting on the document data according to the sort information, to thereby enable the data to be printed out in the output order indicated by the sort information.

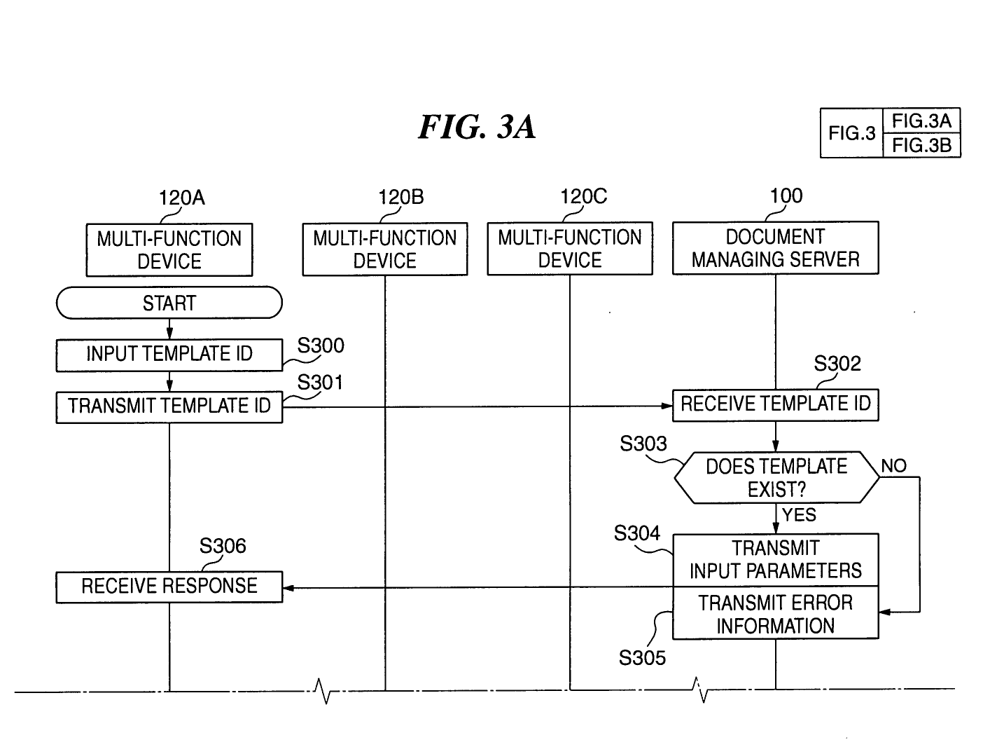

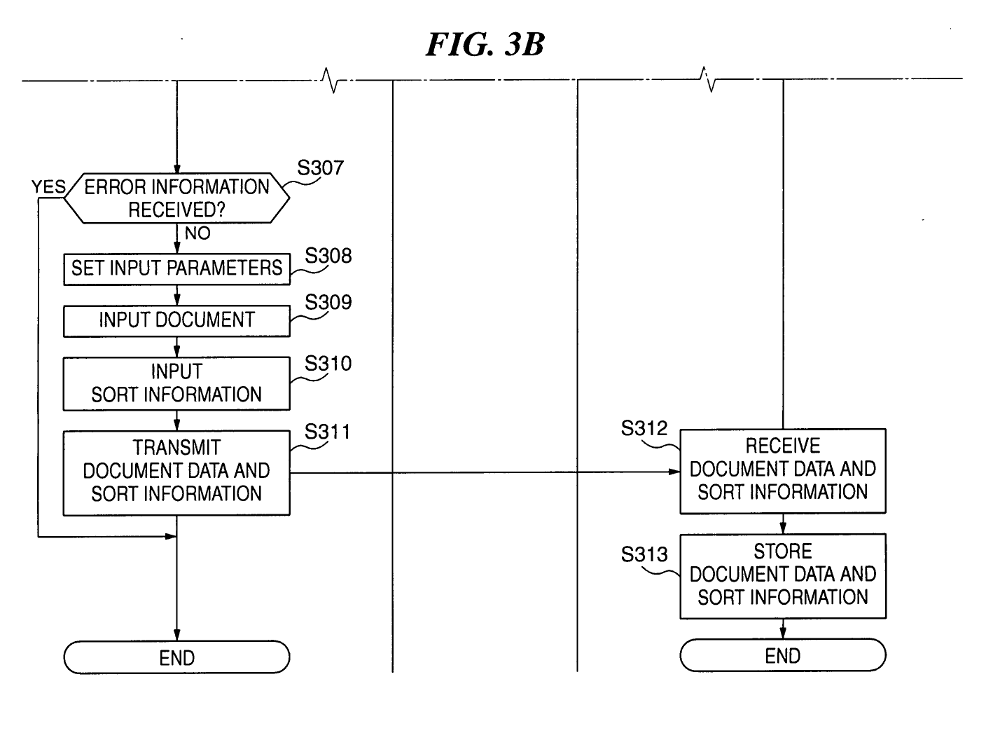

Next, the operation of the document generating system of the present embodiment constructed as above will be described in detail with reference to FIGS. 3 to 5.

FIG. 3A is a flowchart showing a process for uploading document data from the multi-function device 120 (the multi-function device 120A in the illustrated example) to the document managing server 100, and FIG. 3B is a flow chart showing a continued part of the process in FIG. 3A.

In a step S300 in FIG. 3A, an operator inputs a template identifier (ID) (that is, the operator selects a template, and inputs a template identifier assigned to the selected template) for identifying a template of the template file 103 stored in the document managing server 100 through an operating panel of the multi-function device 120, and then the process proceeds to a step S301.

In the step S301, the image input/output control section 121 of the multi-function device 120 transmits the template identifier inputted in the step S300 to the document managing server 100, via the network interface section 122, and then the process proceeds to a step S302. In this case, the address of the document managing server 100 may be inputted in the step S300 through the operating panel of the multi-function device 120 together with the template identifier, or may be stored in advance in the multi-function device 120.

In the step S302, the document managing program 102 of the document managing server 100 receives the template identifier transmitted from the multi-function device 120 in the step S301, via the network interface section 101, and then the process proceeds to a step S303.

In the step S303, the document managing program 102 determines whether or not the template corresponding to the template identifier received in the step S302, is stored in the document managing server 100. If it is determined that the template corresponding to the template identifier is stored (YES to the step S303), the process proceeds to a step S304. On the other hand, if it is determined that the template corresponding to the template identifier is not stored (NO to the step S303), the process proceeds to a step S305.

In the step S304, the document managing program 102 transmits the document data output format that is defined in the template, which are input parameters such as reading size, resolution, reading mode, file format, transmitting method, and destination address including a storage area for the document data, as a response, to the multi-function device 120 via the network interface section 101, and then the process proceeds to a step S306.

In the step S305, the document managing program 102 transmits error information indicative of an error as a response to the multi-function device 120 via the network interface section 101, and then the process proceeds to the step S306.

In the step S306, the image input/output control section 121 of the multi-function device 120 receives the response transmitted from the document managing server 100, and then the process proceeds to a step S307.

In the step S307, the image input/output control section 121 determines whether or not the response received in the above step S306 contains error information. If it is determined that the response contains error information (YES to the step S307), the process is terminated, and if it is determined that the response does not contain error information (NO to the step S307), the process proceeds to a step S308.

In the step S308, the image input/output control section 121 sets the various input parameters for inputting document data, that are contained in the response, to the multi-function device 120, and then the process proceeds to a step S309.

In the step S309, the operator inputs the document data according to the various input parameters set in the step S308 through the operating panel of the multi-function device 120, and then the process proceeds to a step S310.

In the step S310, the operator inputs sort information that is allocated in advance to the operator carrying out document data input by operating the multi-function device 120, through the operating panel of the multi-function device 120, and then the process proceeds to a step S311.

In the step S311, the image input/output control section 121 transmits the document data inputted by the operator in the step 309 and the sort information inputted by the operator in the step S310 to the destination address (document managing server 100 in the illustrated example) contained in the response received from the document managing server 100 in the step S306, via the network interface section 122, and then the process proceeds to a step S312.

In the present embodiment, the destination address of the document data is set to the document managing server 100. However, the destination address may be set to a computer or a storage medium of another device that can be referred to by the document managing server 100 via the network.

In the step S312, the document managing program 102 of the document managing server 100 receives the document data and the sort information transmitted from the multi-function device 120 in the above step S311, via the network interface section 101.

In the following step S313, the document managing program 102 stores the document data and the sort information received in the step S312 in a designated file in the document storage area 104, and the present process is terminated.

By the above procedure, document data is input in the output format that is defined in the template, and the inputted document data is uploaded to the document managing server 100 from the multi-function device 120.

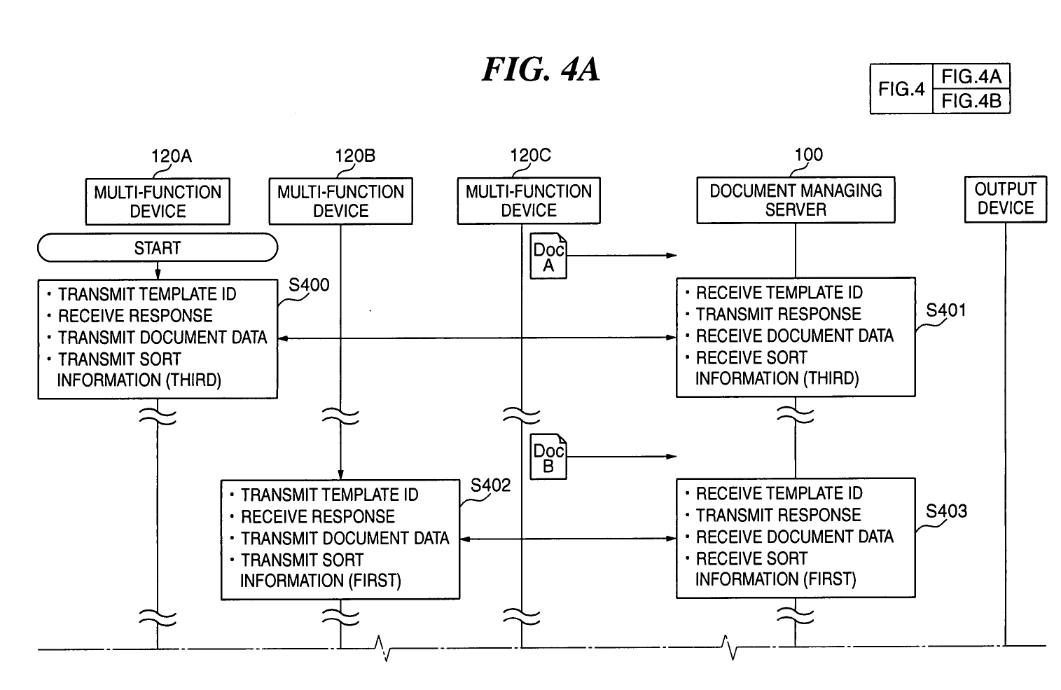

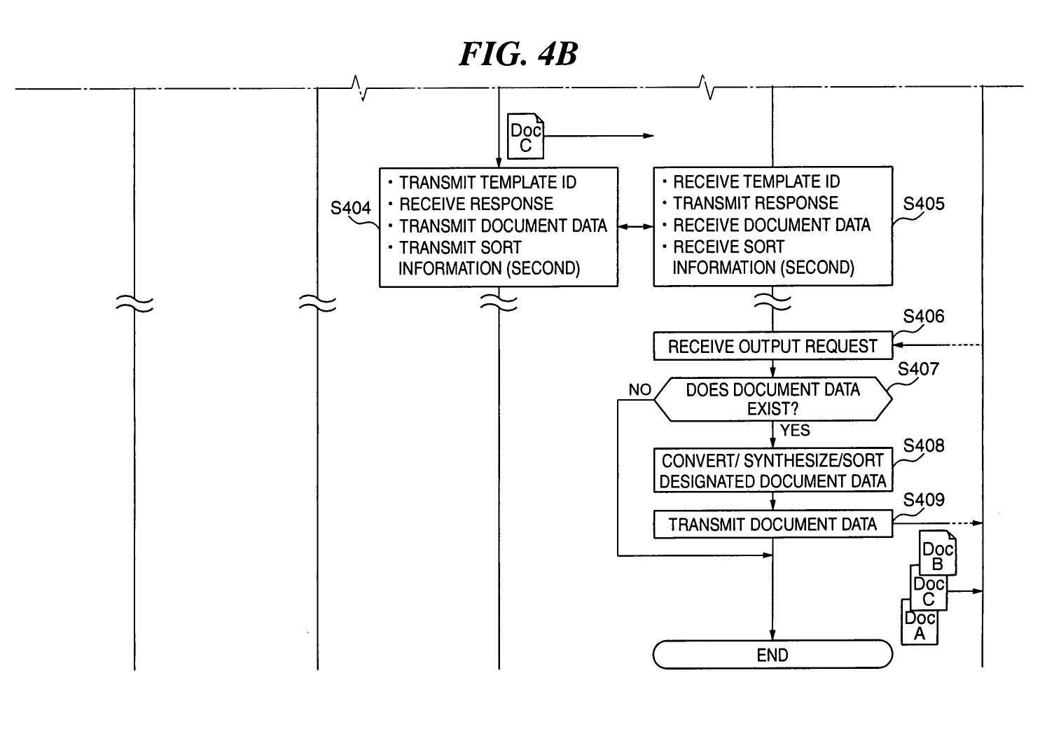

FIG. 4A is a flowchart showing a process for uploading document data from the plurality of multi-function devices 120 (the multi-function device 120A, the multi-function device 120B, and the multi-function device 120C) to the document managing server 100, and outputting document data according to an output request from an output apparatus (for example, a printer) that is connected to the network, and FIG. 4B is a flow chart showing a continued part of the process in FIG. 4A.

In steps S400 and S401 in FIG. 4A, document data (Doc A) inputted to the multi-function device 120A is uploaded together with sort information (indicating that the document data is to be outputted third), to the document managing server 100 through the steps described in FIGS. 3A and 3B.

In steps S402 and S403, document data (Doc B) inputted to the multi-function device 120B is uploaded together with sort information (indicating that the document data is to be outputted first), to the document managing server 100 through the steps described in FIGS. 3A and 3B.

In steps S404 and S405, document data (Doc C) inputted to the multi-function device 120C is uploaded together with sort information (indicating that the document data is to be outputted second), to the document managing server 100 through the steps described in FIGS. 3A and 3B.

In the following step S406, the document managing program 102 of the document managing server 100 receives an output request for outputting document data from an output device connected to the network, via the network interface section 101, and then the process proceeds to a step S407.

In the step S407, the document managing program 102 determines whether or not the document data that has been instructed to be printed out by the output request received in the above step S406, exists. If it is determined that the document data that has been instructed to be printed out exists (YES to the step S407), the process proceeds to a step S408. If it is determined that the document data that has been instructed to be printed out does not exist (NO to the step S407), the present process is terminated.

In the step S408, the document managing program 102 refers to the sort information that has been inputted from the plurality of multi-function devices 120 (the multi-function device 120A, the multi-function device 120B, and the multi-function device 120C) to carry out sorting on each document data (Doc A, Doc B, and Doc C), and then the process proceeds to a step S409. As will be described later with reference to the second embodiment, if a conversion method and a synthesizing method of the document data are defined in the template file that was referred to when each document data (Doc A, Doc B, and Doc C) was generated, conversion and synthesis of the document data are carried out according to the conversion method and the synthesizing method defined therein.

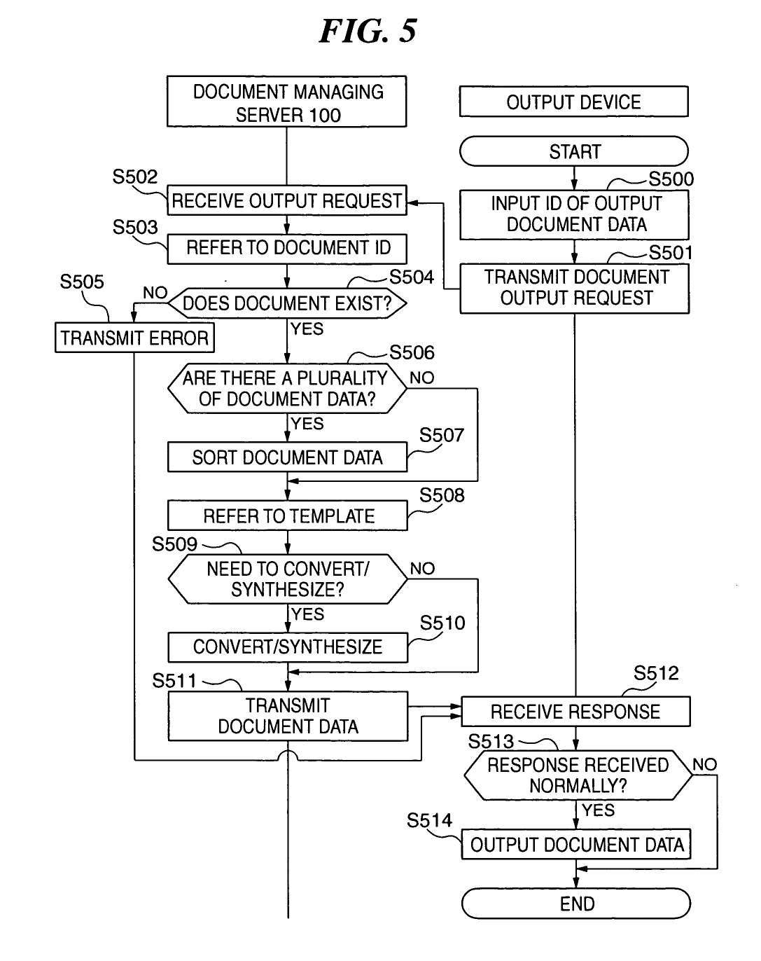

In the step S409, the document managing program 102 transmits the document data that has been subjected to conversion/synthesis/sorting in the above step S408 to the output device via the network interface section 101, and then the process is terminated. The process for outputting the document data will be described below in detail with reference to FIG. 5.

FIG. 5 is a flowchart showing in detail the process carried out when an output device connected to the network requests the managing server 100 to output document data.

In a step S500 in FIG. 5, the operator inputs a document identifier for identifying document data that is stored in the document managing server 100, through the operating section of the output device, and then the process proceeds to a step S501.

In the step S501, the output device transmits a document output request that includes the document identifier inputted in the above step S500, to the document managing server 100, and then the process proceeds to a step S502.

In the step S502, the document managing program 102 of the document managing server 100 receives the document output request transmitted from the output device in the above step S501, via the network interface section 101, and then the process proceeds to a step S503.

In the step S503, the document managing program 102 analyzes the document output request received in the above step S502 and refers to the document identifier for the document data that has been requested to be outputted, and then the process proceeds to a step S504.

In the step S504, the document managing program 102 determines whether or not the document data corresponding to the document identifier referred to in the above step S503 exists. If it is determined that the document data does not exist (NO to the step S504), the process proceeds to a step S505. If it is determined that the document data exists (YES to the step S504), the process proceeds to a step S506.

In the step S505, the document managing program 102 transmits error information to the output device, and the process proceeds to a step S512.

In the step S506, the document managing program 102 determines whether or not there are a plurality of document data corresponding to the document identifier referred to in the above step S503. If it is determined that a plurality of document data exit (YES to the step S506), the process proceeds to a step S507. If it is determined that a plurality of document data do not exist (NO to the step S506), the process proceeds to a step S508.

In the step S507, the document managing program 102 carries out sorting on the plurality of document data by referring to the sort information assigned to the plurality of document data when the document data was created, and then the process proceeds to the step S508.

In the step S508, the document managing program 102 refers to the template used to generate the document data that is designated by the document identifier referred to in the above step S503, and then the process proceeds to the step S509.

In the step S509, the document managing program 102 determines whether or not a conversion method and synthesizing method, which are necessary for the document managing server 100, are defined in the template referred to in the above step S508. If it is determined that a conversion method and a synthesizing method are defined (YES to the step S509), the process proceeds to a step S510. If it is determined that neither a conversion method nor a synthesizing method is defined (NO to the step S509), the process proceeds to a step S511.

In the step S510, the document managing program 102 converts and synthesizes the document data according to the defined conversion method and synthesizing method, and the process proceeds to a step S511.

It should be noted that the process in the step S510 is carried out when a conversion method and a synthesizing method for the document data is defined in the template file, as in the second embodiment, described later. That is, the process of the step S510 is not carried out in the present embodiment.

In the step S511, the document managing program 102 transmits the document data that has been sorted as required in the above step S507 (in the second embodiment described later, conversion and synthesis are carried out in addition to sorting), as a response, to the output device via the network interface section 101.

In the step S512, the output device receives the response transmitted from the document managing server 100, and then the process proceeds to a step S513.

In the step S513, the output device determines whether the response received in the above step S512 is the error information transmitted from the document managing server 100 in the above step S505 or document data transmitted from the document managing server 100. If it is determined that document data has been received normally (YES to the step S513), the process proceeds to a step S514. If it is determined that the error information has been received (NO to the step S513), the present process is terminated.

In the step S514, the output device prints out the document data received in the above step S512 in the output order indicated by the sort information, and then the present process is terminated.

As described above, according to the present embodiment, each multi-function device 120 transmits a template identifier to the document managing sever 100, and upon receipt of the document data input format from the document managing server 100, inputs document data in the received document data input format, transmits the inputted document data and sort information to the document managing server 100. The document managing server 100 sorts the document data transmitted from each multi-function device 120 according to the sort information. Therefore, it is possible for a plurality of users to share an input format for data on a document by document basis and to print a plurality of document data in the proper order.

Next, a description will be given of a data processing system according to the second embodiment of the present invention.

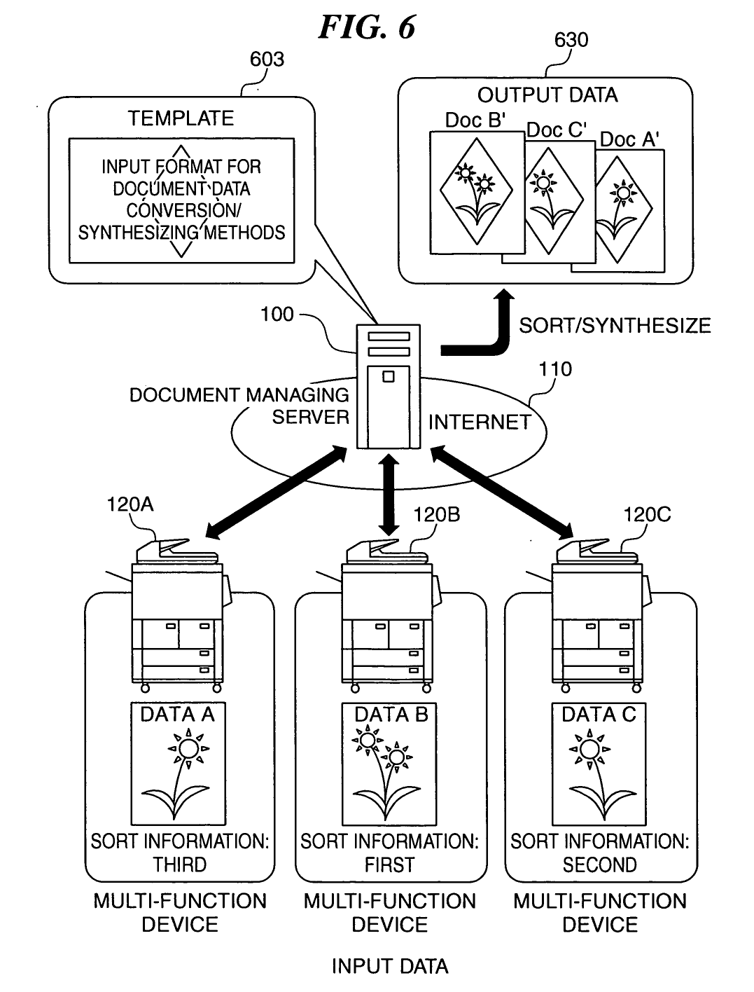

FIG. 6 is a block diagram showing the construction of a document generating system as the data processing system according to the second embodiment.

As shown in FIG. 6, the document generating system is comprised of a document managing server 100 and a plurality of multi-function devices, i.e., the multi-function device 120A, the multi-function device 120B, and the multi-function device 120C, which are connected to the document managing server 100 via the Internet 110.

The second embodiment differs from the first embodiment only in the following points. The other elements of the second embodiment are the same as corresponding ones of the first embodiment described above (FIG. 1), and description thereof is, therefore, omitted.

The document managing server 100 stores a template file 603 consisting of a plurality of templates. Each template of the template file 603 has defined therein an input format of document data (various input parameters including reading size, resolution, reading mode, file format, transmitting method, and destination address including a storage area for document data), and a conversion method and a synthesizing method for document data that are carried out by the document managing server 100.

Each multi-function device 120 (the multi-function device 120A, the multi-function device 120B, and the multi-function device 120C) has a plurality of functions such as a scanner function, a printer function, and a facsimile function, and transmits inputted document data (Doc A, Doc B, and Doc C) to the document managing server 100, by referring to the template file 603 stored in the document managing server 100. Further, together with the document data, each multi-function device 120 transmits sort information indicative of the output order for outputting the document data, to the document managing server 100.

When receiving an output request from an output device (such as a printer), not shown, the document managing server 100 generates document data to be outputted 130 (consisting of Doc B′, Doc C′, and Doc A′) by sorting the document data inputted from each multi-function device 120 with reference to the sort information, and converting and synthesizing the document data according to the document data conversion method and synthesizing method defined in the template file 603 and then transmits the document data to the output device (refer to the steps S509 and S510 in FIG. 5). Thus, it is possible for the output device to print the plurality of document data in the output order indicated by the sort information, and also it is possible to convert and synthesize document data into a unified format.

The processes carried out by each multi-function device 120, the document managing server 100, and the output device (corresponding to the flowcharts in FIGS. 3 to 5) of the present embodiment are basically the same as corresponding ones of the first embodiment described above, except that the document data conversion and synthesis are carried out according to the document data conversion method and synthesizing method defined in the template file 603. Thus description of these processes and the drawing is omitted.

As described above, according to the present embodiment, as in the first embodiment, it is possible for a plurality of users to share an input format for data on a document by document basis and to print a plurality of document data in the proper order. Further, since the document managing server 100 converts and synthesizes document data according to the document data conversion method and synthesizing method defined in the template file 603, a plurality of document data transmitted to the document managing server 100 from each multi-function device 120 can be converted and synthesized into an unified format by the document managing server 100.

Although in the above described first and second embodiments, the present invention is applied to a multi-function device having a plurality of functions such as a scanner function, a printer function, and a facsimile function, as an example of the apparatus which inputs document data, this is not limitative, but the present invention may be applied to a copier having a scanner function and a printer function, an image reading device (scanner) having a scanning function, and the like.

Further, although in the above described first and second embodiments, the reading size, the resolution, the reading, the file format, the transmitting method, and the destination address including a storage area for the document data are given as examples of the input format for document data (parameters), however, the input format for document data (parameters) is not limited to all the above parameters (i.e. the reading size to the destination address) but only parameters as necessary can be applied.

It is to be understood that the object of the present invention may be accomplished by supplying a computer or a CPU with a program of software (corresponding to the processes described in the flowcharts of FIGS. 3 to 5) that realizes the functions of either of the above described embodiments, and causing the computer or the CPU to read out and execute the supplied program.

In this case, the program is supplied directly from a storage medium in which it is recorded or by downloading it from another computer, database, or the like, all of which are not shown, connected to the Internet, a commercial network, a local area network, or the like.

The above program may be an object code, a program code executed by an interpreter, script data supplied to an OS, or the like.

Furthermore, it is to be understood that the object of the present invention may also be accomplished by supplying a computer or a CPU with a storage medium in which a program code of software which realizes the functions of either of the above described embodiments, and causing the computer or the CPU to read out and execute the program code stored in the storage medium.

In this case, the program code itself read from the storage medium realizes the functions of either of the above described embodiments, and hence the program code and the storage medium in which the program code is stored constitute the present invention.

Examples of the storage medium for supplying the program code include a ROM, a RAM, a NV-RAM, a floppy (registered trademark) disk, a hard disk, a magnetic-optical disk, an optical disk including a CD-ROM, a CD-R, a CD-RW, a DVD-ROM, a DVD-RAM, a DVD-RW, and a DVD+RW, a magnetic tape, and a nonvolatile memory card.

Further, it is to be understood that the functions of either of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or in an expansion section connected to the computer and then causing a CPU, a MPU or the like provided in the expansion board or the expansion section to perform a part or all of the actual operations based on instructions of the program code.

As many apparently widely different embodiments of the present invention can be made without departing from the spirit and scope thereof, it is to be understood that the invention is not limited to the specific embodiments thereof except as defined by the appended claims.

### CROSS REFERENCE TO RELATED APPLICATION

This application claims priority from Japanese Patent Application No. 2004-256207 filed Sep. 2, 2004, which is hereby incorporated by reference herein.

What is claimed is:

1. A data processing system comprising:
a document input apparatus that inputs document data; and
a document managing apparatus that stores templates each defining therein an input format for document data, said document input apparatus and said document managing apparatus being connected to each other for communication therebetween,
wherein:
said document input apparatus comprises:
a first transmission section that transmits information used for selecting a template to said document managing apparatus;
a first reception section that receives an input format defined in the template for document data from said document managing apparatus;
a setting section that sets the received input format;
an input section that inputs document data according to the set input format; and
a second transmission section that transmits the document data inputted according to the set input format with addition of information indicative of a processing method, to said document managing apparatus; and
said document managing apparatus comprises:
a second reception section that receives the information used for selecting a template from said document input apparatus;
a third transmission section that transmits an input format defined in the template to said document input apparatus;
a third reception section that receives the document data and the information indicative of the processing method from said document input apparatus; and
a processing section that processes the document data according to the information indicative of the processing method.

2. A data processing system as claimed in claim 1, wherein the information indicative of the processing method is sort information indicative of an output order, and said document managing apparatus carries out sorting on the received document data according to the sort information.

3. A data processing system as claimed in claim 1, wherein the input format for document data includes at least one parameter selected from the group consisting of reading size, resolution, reading mode, file format, transmitting method, and destination address including a storage area for the document data.

4. A data processing system as claimed in claim 1, wherein the templates each define therein a conversion method and a synthesizing method for document data in addition to the input format for document data, and said document managing apparatus converts and synthesizes the received document data according to the conversion method and the synthesizing method defined in a selected one of the templates.

5. A data processing system as claimed in claim 1, comprising at least one output device that is connected to said document managing apparatus for communication therewith, for printing out document data, and
wherein said document managing apparatus comprises a fourth transmission section that is operable when document data corresponding to a document identifier received from said output device exists, to transmit the corresponding document data, to said output device.

6. A document input apparatus that can communicate with a document managing apparatus storing templates each defining therein an input format for document data, comprising:
a first input section that inputs information used for selecting a template;
a first notifying section that transmits the information used for selecting a template inputted by said first input section to said document managing apparatus;
a reception section that receives an input format defined in the template for document data from said document managing apparatus;
a setting section that sets the received input format;
a second input section that inputs document data according to the set input format; and
a second notifying section that transmits the document data inputted according to the set input format, with addition of information indicative of a processing method, to said document managing apparatus.

7. A data input apparatus as claimed in claim 6, wherein the information indicative of the processing method is sort information indicative of an output order.

8. A data input apparatus as claimed in claim 6, wherein the input format for document data includes at least one parameter selected from the group consisting of reading size, resolution, reading mode, file format, transmitting method, and destination address including a storage area for the document data.

9. A document managing apparatus that can communicate with at least one document input apparatus that inputs document data, comprising:
a storage section that stores templates each defining therein an input format for document data;
a first reception section that receives information used for selecting a template from said document input apparatus;
a notifying section that is operable when one of the templates corresponding to the information used for selecting a template is stored in said storage section, to transmit the input format for document data defined in the corresponding template to the document input apparatus;
a second reception section that receives the document data and the information indicative of a processing method from said document input apparatus; and
a processing section that processes the document data according to the information indicative of the processing method.

10. A document managing apparatus as claimed in claim 9, wherein the information indicative of the processing method is sort information indicative of an output order, and said processing section carries out sorting on the received document data according to the sort information.

11. A document managing apparatus as claimed in claim 9, wherein the input format for document data includes at least one parameter selected from the group consisting of reading size, resolution, reading mode, file format, transmitting method, and destination address including a storage area for the document data.

12. A document managing apparatus as claimed in claim 9, wherein the templates each define therein a conversion method and a synthesizing method for document data in addition to the input format for document data, and said processing section converts and synthesizes the received document data according to the conversion method and the synthesizing method defined in a selected one of the templates.

13. A document managing apparatus as claimed in claim 9 that can communicate with at least one output device that prints document data, and wherein the document managing apparatus transmits document data corresponding to a document identifier received from the output device, to said output device, when the corresponding document data exists.

14. A control method of controlling a data processing system comprising a document input apparatus that inputs document data, and a document managing apparatus that stores templates each defining therein an input format for document data, the document input apparatus and the document managing apparatus being connected to each other for communication therebetween, the control method comprising:
a first transmitting step of transmitting information used for selecting a template to said document managing apparatus;
a first receiving step of receiving an input format defined in the template for document data from said document managing apparatus;
a setting step of setting the received input format;
an input step of inputting document data according to the set input format;
a second transmitting step of transmitting the document data inputted according to the set input format with addition of information indicative of a processing method, to said document managing apparatus;
a second reception step of receiving the information used for selecting a template from said document input apparatus;
a third transmitting step of transmitting an input format defined in the template to said document input apparatus;
a third receiving step of receiving the document data and the information indicative of the processing method from said document input apparatus; and
a processing step of processing the document data according to the information indicative of the processing method,
wherein said first transmitting step, said first receiving step, said setting step, and said second transmitting step are carried out by said document input apparatus, and said second receiving step, said third transmitting step, said third receiving step, and said processing step are carried out by the document managing apparatus.

15. A control method of controlling a document input apparatus that can communicate with a document managing apparatus storing templates each defining therein an input format for document data, comprising:
a first notifying step of transmitting information used for selecting a template to the document managing apparatus;
a setting step of setting the received input format;
an input step of inputting document data according to the set input format; and
a second notifying step of transmitting document data inputted according to the input format set in said setting step, with addition of information indicative of a processing method, to the document managing apparatus.

16. A control method of controlling a document managing apparatus that can communicate with at least one document input apparatus that inputs document data, comprising:
a storing step of storing templates each defining therein an input format for document data in a storage device of the document managing apparatus;
a first receiving step of receiving information used for selecting a template from said document input apparatus;
a notifying step of transmitting the input format for document data defined in one of the templates corresponding to the information used for selecting a template to the document input apparatus when the corresponding template is stored in the storage device;
a second receiving step of receiving the document data and the information indicative of a processing method from said document input apparatus;
a processing step of processing the document data according to the information indicative of the processing method.

17. A program for causing a computer to execute the control method of controlling a document input apparatus as claimed in claim 15.

18. A program for causing a computer to execute the control method of controlling a document managing apparatus as claimed in claim 16.

19. A computer-readable storage medium storing the program as claimed in claim 17.

20. A computer-readable storage medium storing the program as claimed in claim 18.
